(19) United States
(12) Patent Application Publication
(10) Pub. No.: US 2015/0302452 A1
(43) Pub. Date: Oct. 22, 2015

(54) Content Subscription Rewards System

(71) Applicant: Michael Scott Freeman, Smyrna, GA (US)

(72) Inventor: Michael Scott Freeman, Smyrna, GA (US)

(21) Appl. No.: 14/254,891

(22) Filed: Apr. 16, 2014

(51) Int. Cl. G06Q 30/02

(52) U.S. Cl. CPC G06Q 30/0226; G06Q 30/0213

(57) ABSTRACT

A content subscription rewards system includes a qualified subscriber computer, an Internet connected media device and a rewards database in communication with a software application via a network that allows a qualified subscriber to access publisher content and a rewards database, wherein said publisher content is provided without any advertisements.

### FIELD OF THE INVENTION

Certain embodiments of the invention relate to a content subscription rewards system. More specifically, certain embodiments of the invention relate to a method and system for subscribers to consume content without advertisements and to provide rewards to qualifying subscribers of the content subscription rewards system. The system is architected to convert free users into subscribers of the publisher's content or service, and thereby drive increased subscription revenues for the publishers, increased sales for brands and retailers, and increased user satisfaction for qualified subscribers.

### BACKGROUND OF THE INVENTION

Users consume (i.e. access, view, manage, and share) publisher content and services on various platforms by connecting to the Internet with a variety of connected media devices through various means including but not limited to web browsers and native, HTML5, and hybrid applications. Users consume publisher content both online and offline. Online content is inclusive of news media, streaming media (i.e. music, video, and TV), cloud-based file sharing and storage, video conferencing and media sharing, social networking, and gaming. Offline content includes URLs, data files, and the like that are stored or transferred to a database of the user or accessible by the user while offline or not connected to the Internet. The content consumption experience of users may take place on Internet connected media devices such as mobile phones, smartphones, tablets, laptop computers, MP3 players, game consoles, desktop computers, televisions, cable set top boxes, and consumer appliances. While consuming content from an Internet connected media device of choice, users are constantly inundated with an abundance of advertisements and superfluous content that distracts the user from enjoying their intended experience. The distractions caused by advertisements usually deter a user from continuing to consume the publisher content and often result in the publisher losing a potential subscriber.

It is common for publishers to have a revenue model that is almost exclusively dependent upon advertising revenue. As such, increased advertisements drive greater revenues for publishers, yet are intrusive to the user's experience. For instance, conventional methods of viewing or accessing content usually results in the user being forced to witness an irrelevant infomercial or commercial from an advertiser before the user can actually view the intended content. Additionally, the user may receive several pop-up windows for unsolicited advertisements, and/or be otherwise redirected to third-party content from an advertiser. The methods of consuming content in the prior art typically frustrate a user, make the simple goal of consuming content a cumbersome task, and drive the user to consider other sources for their content consumption needs. For example, a user may attempt to watch content a short 30-second sports highlight but will be redirected to a pre-roll ad or commercial that is longer than its intended content. Furthermore, the advertisement that the user is forced to watch is usually unrelated to the user's selected content. As a result, publishers are not presenting a compelling user experience that can feed their business models. Some alternative methods of consuming content are based on a “Freemium” model wherein a publisher reserves certain features and functionality for paying subscribers while making the remainder of their product or service available for free. This method typically encourages high volumes of free users and low subscriber conversion rates (i.e. 1-2% of the free user base), but the actual user experience is still disrupted with highly irrelevant, intrusive, and time-consuming ads. Combined with other viable, and even free, sources for like content, these factors tend to cause users to become reluctant to subscribe to any offerings of published content. Oftentimes, in an effort to consume content without any interruption from the noise of advertisements, users will result to downloading and installing ad blocking software to completely block any third party advertisements and pop-ups from interrupting their content viewing experience.

Other methods of consuming content available in the prior art include using the mass approach of digital advertising that has been largely ineffective in reaching users and is inefficient at converting a publishers users to purchasing consumers of a brand's products and/or services. This method fails because it is wasteful of a brand's advertising revenue as it is does not properly convert a sufficient number of the publishers users to the brand's customer, nor does it effectively monetize the publishers digital content and services. As such, publishers of digital content are challenged to add new subscribers in an effort to effectively execute their business model. Publishers have not been able to effectively answer this challenge as evidenced by the fact that standard publisher subscription conversion rates are on average less than 2%. Therefore, publishers are heavily reliant on advertising revenues to monetize user consumption of their content or services. As the value of advertising space is being eroded due to the increase of available advertising opportunities across the Internet, publishers are forced to increase the amount of un-wanted advertising, in an effort to cover costs and generate profits. Forcing publishers to continually intrude upon the users content consumption experience.

Additionally, the current methods of monetizing publisher content are inefficient at providing publishers the ability to sustain business operations with advertising revenue. As such, the value of the cost per thousand impressions (CPM) for advertising is driven down due to the expansion of the Internet and the availability of more advertising opportunities. Similarly, the value of the advertising space is also driven down so publishers can't charge the same cost for the advertising space. Thus, publishers are forced to run more advertisements to offset the decrease in advertising revenue, which is interfering with user experience and frustrating users. As a result, publishers are seeking alternative models for monetizing content.

The shortcoming with the current methods of monetizing publisher content is largely because CPM is the only viable metric used to measure and compare web analytics associated with advertising. It refers to the cost of Internet marketing or an email advertising campaign where advertisers pay for every thousand instances an ad is displayed. Specifically, it is the cost to offer potential customers one thousand opportunities to see the advertisement. CPM is the closest online advertising strategy to those offered in other media forms such as television or print, which sell advertising based on estimated viewership or readership. CPM provides a comparable measure to contrast Internet advertising. Nonetheless, this method of monetizing the eyes of free users and the related tools for measuring the analytics of free users consuming the content is an inefficient use of publisher resources. For instance, in 2010 brands spent approximately $24.5 billion dollars on digital advertising, that resulted in an average click through rate (CTR) of only 6%; which is considered a success by current industry standards. In other words, 94% of the users did not click through to view advertised content. The resulting effect devalues CPMs, which in turn negatively impact the publisher's primary, if not only, source of revenue. The publisher is now forced to consider these three options: (i) increase the available real estate for advertisements at the expense of their content and user experience, (ii) do nothing different and suffer the consequences of diminished CPMs, and risk losing users which further depresses CPM capacity, and (iii) develop alternate, viable sources of revenue. Publishers are pursuing options (i) and (ii), which are conflicting initiatives to their experience model and business model, respectively.

Accordingly, it is an object of this invention to provide a content subscription rewards system, which provides an improved method of converting a publisher's free user base into qualified subscribers without interrupting said publisher content with advertisements, while also providing rewards to said qualified subscribers, and overcoming one or more of the aforementioned problems of existing systems. Thus, the invention also provides an apparatus for providing a content subscription rewards system to allow a qualified subscriber to view content without advertising.

Further limitations and disadvantages of conventional and traditional approaches will become apparent to one of skill in the art, through comparison of such systems with the present invention as set forth in the remainder of the present application with reference to the drawings.

### BRIEF SUMMARY OF THE INVENTION

A method and/or content subscription rewards system for converting free users into subscribers of a publisher's content or service via providing consumer rewards behind said publisher's pay wall, and enabling the qualified subscriber full access to consume said publisher's content without advertisements, substantially as shown in and/or described in connection with at least one of the figures, as set forth more completely in the claims.

Various advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram illustrating an exemplary content subscription system, in accordance with an embodiment of the invention.

FIG. 2 is a block diagram illustrating an exemplary subscriber's computer and a connected media device in communication through a network, software application and rewards database, in accordance with an embodiment of the invention

FIG. 3 is a flow chart illustrating exemplary steps involved on obtaining related rewards across all platforms, in accordance with an embodiment of the invention.

FIG. 4 is a block diagram illustrating exemplary steps of querying the rewards database for rewards, in accordance with an embodiment of the invention.

FIG. 5 illustrates an exemplary online publisher experience with interactive content, in accordance with an embodiment of the invention.

FIG. 6 illustrates an exemplary online publisher experience with interactive content, in accordance with an embodiment of the invention.

FIG. 7 illustrates an exemplary online publisher experience with interactive content, in accordance with an embodiment of the invention.

FIG. 8 is a flow chart illustrating exemplary steps for linking rewards on an Internet connected media device, in accordance with an embodiment of the invention.

### DETAILED DESCRIPTION OF THE INVENTION

Certain embodiments of the invention can be found in a content subscription rewards system that provides a qualifying subscriber access to view publisher content without advertisements and access to a rewards database. This system is architected to convert free users into subscribers of the publisher's content or service, and thereby drive increased subscription revenues for the publishers, increased sales for brands and retailers, and increased user satisfaction for subscribers.

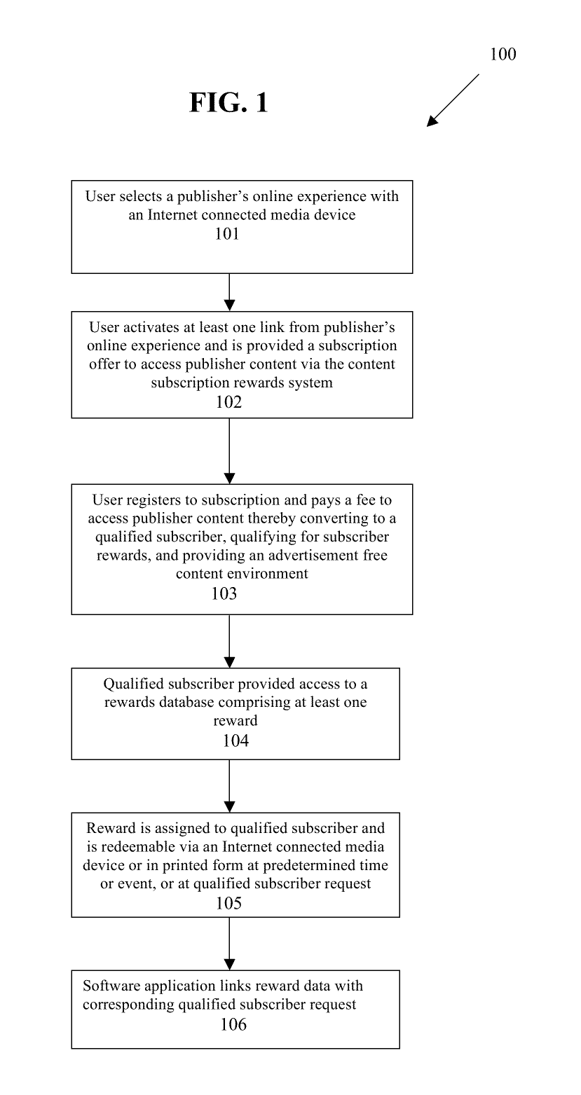

FIG. 1 depicts an exemplary content subscription rewards system 100 in accordance with an embodiment of the present invention. Illustrative steps involved in providing the content subscription rewards system 100 are depicted in FIG. 1. At step 101, a user views a publisher's online presence via a website or the like with an Internet connected media device 230. At step 102, the user activates at least one link from the publisher's online presence 230 and is provided a subscription offer to access content of publisher, free of advertisements, and access to at least one reward and related database as a qualifying subscriber. At step 103, the user registers for a subscription to publication service and pays a fee to consume publisher content thereby converting to a qualified subscriber. At step 104, the qualified subscriber is provided access to a rewards database comprising at least one reward. At step 105, at least one reward is selected by and assigned to the qualified subscriber and is redeemable via an Internet connected media device 230 or in printed form at a predetermined time, event, or at subscriber request. At step 106, a software application 250 links reward data with the corresponding qualified subscriber reward. A publisher's online presence may be provided via a website, application or the like to provide access to a publisher's content via the Internet. In another embodiment of the present invention, a qualified subscriber can consume publisher content offline, wherein offline content includes URLs, data files, and the like that are stored or transferred to a database of the user or accessible by the user while offline or not connected to the Internet.

The content subscription rewards system 100 can provide at least one publisher with the ability to promote content while simultaneously providing at least one qualifying subscriber with at least one reward. A reward can include coupons, special deals and discounts that may or may not be related to a product or service of the publisher and may or may not be exclusive to the rewards database. The content subscription rewards system 100 provides a rewards based system, positioned behind the publisher's subscription pay wall, in which a reward can include any type of a special deal or discount to the qualified subscriber that reduces the purchase price of a brand's or retailer's product or service offered for sale via the rewards database. A pay wall is a system that prevents free users from accessing a publisher's content without a paid subscription. The content subscription rewards system 100 provides value to publishers, brands, and qualified subscribers as the reward relates directly to products and services that qualified subscribers have an interest in purchasing. Thereby, the content subscription rewards system 100 creates a unique system that can be used to reward the publisher with increased subscription conversion rates, reward the brands with incentivized consumers, and reward the qualifying subscriber with deals accessible exclusively behind the protected subscription pay wall. The content subscription rewards system 100 can also provide a basis for a publisher to charge higher subscription rates as a result of delivering additional value to the consumer.

The content subscription rewards system 100 can also provide at least one qualifying subscriber with the ability to interactively communicate with a plurality of publishers or a plurality of qualified subscribers. As a result, the content subscription rewards system 100 can be used by a plurality of publishers to provide a plurality of rewards to multiple qualified subscribers. Thus, the content subscription rewards system 100 may allow a publisher to increase subscriber revenues and content consumption by converting users or non-subscribers into qualified subscribers of the content subscription rewards system 100.

In various embodiments of the invention, a first media device such as the qualified subscriber's computer 210 or other Internet connected media device 230, which is coupled to the content subscription rewards system 100, may be paired with or associated with a second Internet connected media device such as the qualified subscriber's Internet connected media device 230 utilizing a companion software application 250 downloaded in and running on the qualified subscriber's Internet connected media device 230. The qualified subscriber's Internet connected media device 230 may be operable to enable the publisher's online experience to display, utilizing the content subscription rewards system 100, within a section of an online experience, interactive rewards on the qualified subscriber's Internet connected media device 230. The qualified subscriber's Internet connected media device 230 may be operable to enable, utilizing the content subscription rewards system 100, a qualified subscriber to engage with the interactive rewards.

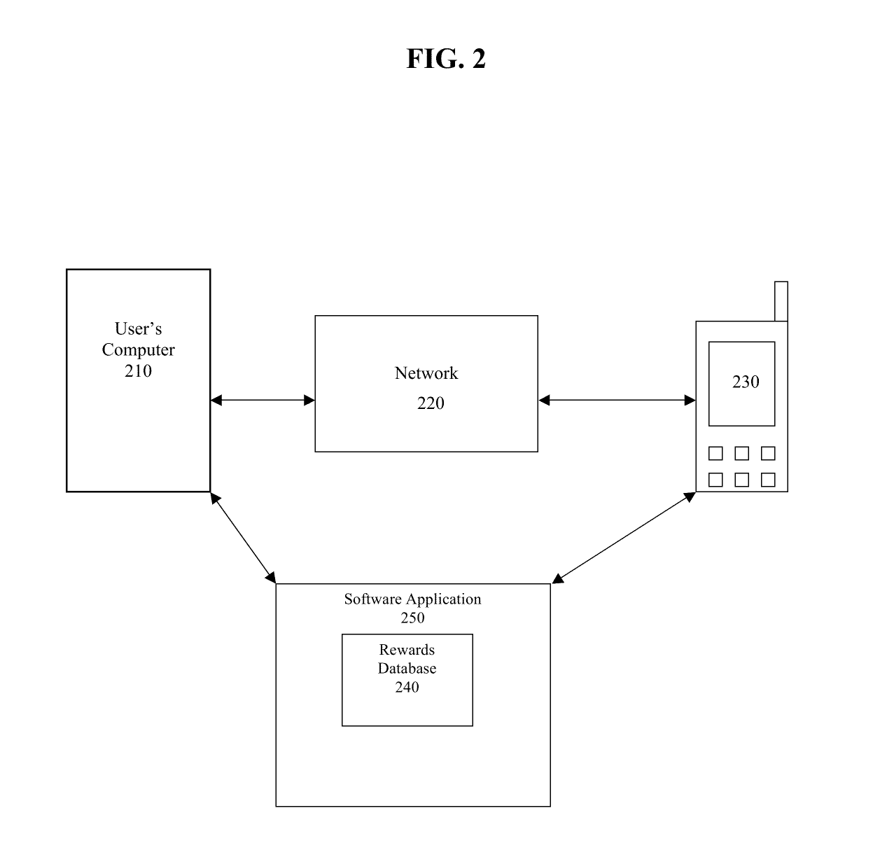

FIG. 2 is a block diagram illustrating an exemplary qualified subscriber's computer 210 in communication with the Internet connected media device 230 through a network 220, software application 250 and rewards database 240, in accordance with an embodiment of the invention. Referring to FIG. 2, the wireless network 220 is in communication with the qualified subscriber's computer 210. In this embodiment, rewards accessible in the rewards database 240 may be transferred via the wireless network 220. The network 220 then retransmits the rewards data, at the request of authorized subscribers of the Internet connected media device 230 connected to qualified subscriber's account. The connected media device 230 through its transmitter or receiver adapted to the Internet connected media device 230 subsequently receives the data. The network 220 may be configured to transfer rewards data between a plurality of devices. For instance, the network 220 may comprise a wireless communications terminal that communicates wirelessly with the Internet connected media device 230 and wirelessly or through wires to a public switched phone network, wide area network, local area network, or otherwise, that is connected to the rewards database 240. The network 220 may also communicate with the Internet connected media device 230 over wires. For example, the Internet connected media device 230 may be connected to a computer system via a universal serial bus (USB) port, or otherwise, and the computer system may be connected to a local area network (LAN), wide area network (WAN), public switched telephone network (PSTN), or otherwise. The LAN, WAN, PSTN, or otherwise, may communicate directly to the server or through additional networks.

The network 220 can comprise a processor and a memory. The content subscription rewards system 100 can communicate with the software application 250, in communication with the rewards database 240. The software application 250 may include computer readable software and a server engine for causing the network 220 to communicate with the Internet connected media device 230. The software application 250 may be downloadable from the publisher's online experience, website, or an application store such as the Apple App Store, Google Play Store or the like. In an alternate embodiment, the rewards data may be displayed as within the display area of the Internet connected media device 230, stored on the qualified subscriber's computer 210, or within a subscriber account in connection with the software application 250 to be viewed later by the qualified subscriber.

In another embodiment of the present invention, the content subscription rewards system 100 can include analytics components that can be used to determine which qualified subscribers are interacting with certain publisher content and what those qualified subscribers are watching based on information received from the servers communicating with the rewards database 240. Analytic information and data related to the qualified subscriber may also be used to communicate with third-party partners/advertisers. The content subscription rewards system 100 can also provide the ability to map data into a rewards analytics engine of the rewards database 240. Although not shown in FIG. 2, the content subscription rewards system 100 may communicate with one or more advertisement servers. The advertisement servers may be utilized to deliver advertisement overlays to the software application 250 running on the qualified subscriber's Internet connected media device 230. The advertisement servers may also be operable to support the tracking of user impressions and click-throughs and/or to perform other advertising-related functions. The content subscription rewards system 100 may utilize one or more technologies to fulfill consumer requests that occur in connection with the software application 250 and qualified subscriber interaction. Examples of such technologies may comprise, but need not be limited to, coupon delivery technologies, technologies for movie ticket purchases and delivery, and/or short message service/multimedia messaging service (SMS/MMS) gateways.

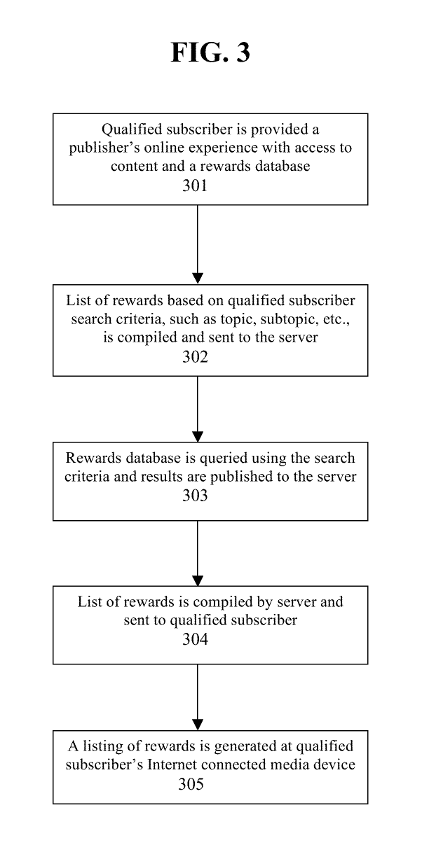

Illustrative steps involved in providing rewards to the qualified subscriber are depicted in FIG. 3. At step 301, the qualified subscriber is provided access to a publisher online experience to consume content. This online experience can provide a link that allows the subscriber to automatically access a list of rewards from the rewards database. At step 302 a set of search criteria is assembled. Step 302 may occur at the qualified subscriber's computer 210, or at a remote server, such as a server in connection with the rewards database 240. In addition, portions of the search criteria, such as a qualified subscriber profile, or topics related to content viewed via the publisher's online experience may reside on the remote server, as opposed to the qualified subscriber's computer. After this information is compiled the database is queried at step 303. This query can be implemented in many manners, including use of a SQL database and query. At step 304, a set of related rewards, such as groceries, clothing, coupons and the like, is determined. The rewards can include any type of reward based on qualified subscriber's preferences. These rewards are provided to the server and then relayed to the user at step 305. It should be acknowledged that the format in which the reward is presented can be determined at the server, at the qualified subscriber's computer or at the qualified subscriber's Internet connected media device 230.

The qualified subscriber's Internet connected media device 230 may comprise suitable logic, circuitry, interfaces and/or code that may be operable to receive content for presenting to a qualified subscriber such as the display, screen, or controlling interface of said Internet connected media device 230. The content may comprise interactive content for the qualified subscriber to interact. In addition to receiving rewards via the content subscription rewards system 100, the Internet connected media device 230 may receive content from the Internet via the communication network 220. In an exemplary embodiment of the invention, the Internet connected media device 230 may comprise suitable logic, circuitry, interfaces and/or code that may be operable to provide rewards to automatically communicate with the content subscription rewards system 100, via the communication network 220, to send rewards to the qualified subscriber's Internet connected media device 230. In an exemplary embodiment of the invention, the qualified subscriber's Internet connected media device 230 may be operable to enable an online experience to display, utilizing the content subscription rewards system 100, within a section of the online experience, interactive content related to certain content being presented by the Internet connected media device 230. In addition, the size of the section may be changed responsively based on information included in the interactive content. The location of the section online experience may be changed based on browsing experience of the qualified subscriber such as, for example, searching items, accessing emails or browsing websites. The qualified subscriber's Internet connected media device 230 may be operable to enable, utilizing the content subscription rewards system 100, a qualified subscriber to interact with the interactive content.

The Internet connected media device 230 may comprise suitable logic, circuitry, interfaces and/or code that may be operable to pair with the qualified subscriber's computer 210. Communication between the qualified subscriber's computer 210 and the Internet connected media device 230 may occur via a wireless communication protocol such as, for example, Wi-Fi or near field communication (NCF). Those with skill in the art will understand that the network of the Internet connected media device 230 can also be configured to utilize Bluetooth or other similar technology. The Internet connected media device 230 may pair with the qualified subscriber's computer 210 utilizing the companion software application 250 downloaded in the Internet connected media device 230. For example, the companion software application 250 may comprise a sync application downloaded in the Internet connected media device 230 from the subscriber's computer 210. The Internet connected media device 230 may comprise, for example, a mobile phone, smartphone, tablet, laptop, MP3 player, computer, TV, cable set top box, game console, and consumer appliance. In an exemplary embodiment of the invention, the Internet connected media device 230 may comprise a browser or other means to manage online experiences. The online experience may be enabled by the subscriber's computer 210 utilizing the content subscription system 100, to display, within a section of the online experience, interactive content related to certain content being presented by the qualified subscriber computer 210.

It should be recognized that the qualified subscriber query need not occur at a dedicated server, such as the server connected to the rewards database 240. Applications for media devices, such as programs, can be queried from those entities, which regularly provide mobile device applications, or organizations that test, review and publicize such applications. It should be understood that these databases may be affiliated or unaffiliated. In the case that they are unaffiliated, a primary server is used to coordinate communication to the servers and aggregating results of the parallel queries. It should also be understood that this process can occur at the same time the qualified subscriber requests and receives any information or link related to a reward, after the qualified subscriber has explicitly chosen to receive a reward or related content from the rewards database, or using other variations with respect to when the process occurs.

In another embodiment of the present invention, a qualified subscriber can link rewards or content from the rewards database 240 on the Internet connected media device 230 using a browser or other means to manage online experiences. For example, the subscriber's computer 210 which is paired with or associated with the Internet connected media device 230 may present certain publisher content in the display of the Internet connected media device 230. The location where the rewards or content is displayed can be changed by the qualified subscriber to accommodate the browsing experience of the qualified subscriber.

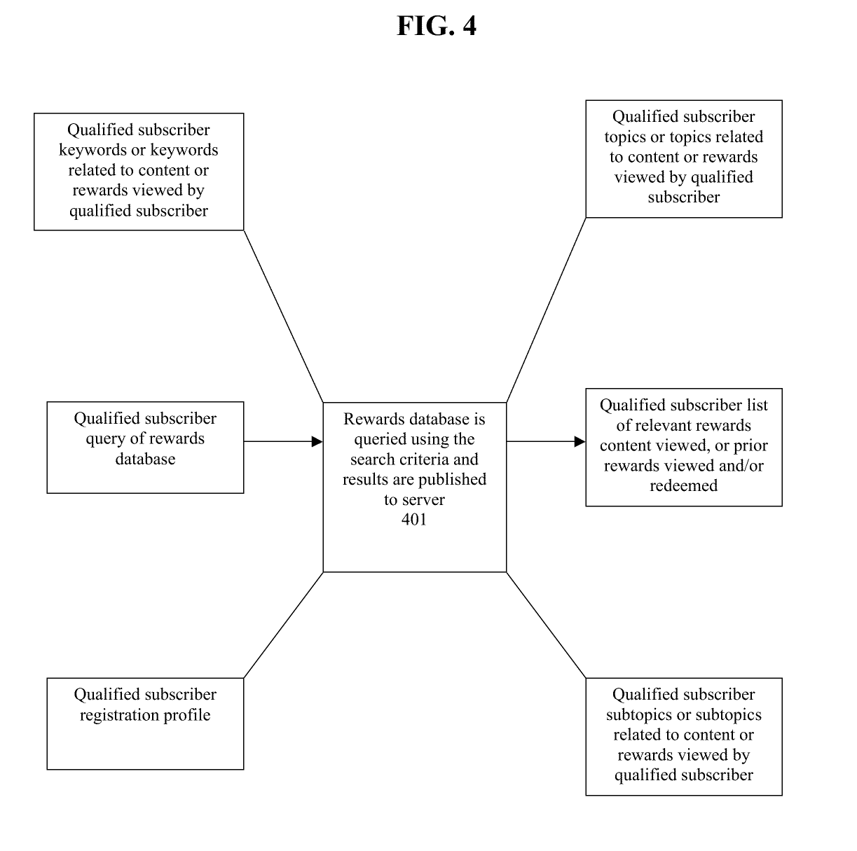

FIG. 4 graphically depicts the method by which the rewards database may be queried to provide a list of related rewards to the qualified subscriber. A number of criteria, such as the type of content being consumed by the qualified subscriber, subtopics and keywords from the content or prior rewards, may all be used query database 401. In addition, the query may take into account registration information of the qualified subscriber input into the rewards database 240 by qualified subscriber, which may contain information specific to qualified subscriber, such as may contain qualified subscriber's interest and hobbies, occupation, location, or statistical information regarding prior content consumed or prior rewards received by qualified subscriber. The qualified subscriber profile can be completed upon registration to the content subscription rewards system 100, changed subsequent to qualified subscriber's registration, or based on the qualified subscriber's content consumption history. The qualified subscriber's profile can be analyzed and used by a query through typical means, such as the entry of a login and password, or through the use of data saved by the qualified subscriber's browser or other Internet access system. In addition, the qualified subscriber's Internet Service Provider can use their unique Internet Protocol address, or an alternate network identifier to determine the qualified subscriber querying information. A query of the rewards database 401 making use of all, or any subset of these criteria, will yield a display of related content to be provided to the qualified subscriber. In addition, the query may take at the time the qualified subscriber first loads an online article into his web browser or Internet capable device or after the qualified subscriber has explicitly requested related content.

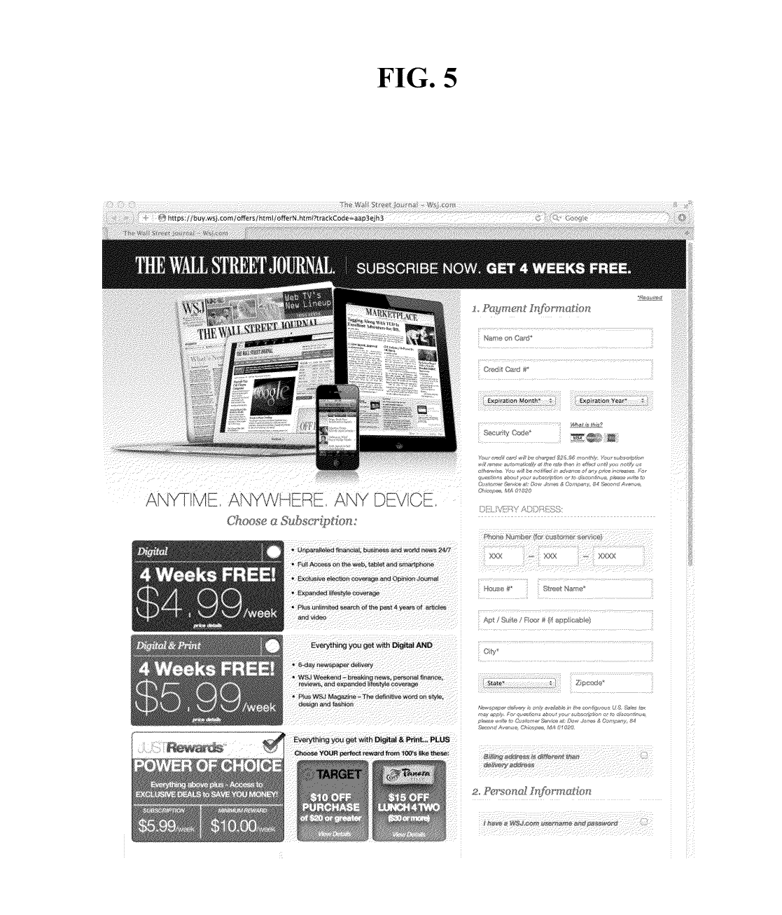

FIG. 5 illustrates an exemplary publisher website, in accordance with an embodiment of the invention. In accordance with an embodiment of the present invention, the publisher can include an online news media publication, such as the Wall Street Journal. Referring to FIG. 5, the publisher is providing a reward comprising a 4-week free subscription to designated content. The publisher is also offering a second reward comprising 5-week free subscription to designated content. Additionally, the website includes a link comprising an interface that allows a user or subscriber to directly access additional publisher rewards offered by other publishers. In another embodiment of the invention, the content subscription rewards system 100 can allow a publisher to offer a plurality of rewards for a broad range of products and services via the publisher site. As shown in FIG. 5, the publisher site includes a reward for a Target coupon for $10 off a subscriber purchase, a Panera reward for $15 dollars off lunch for two people, and a JUSTRewards reward for an offer for a subscription for $5.99 or $10 subscription for a new qualifying subscriber. Additionally, the content subscription reward system 100 allows qualified subscribers to choose rewards from a wide array of brands and retailers.

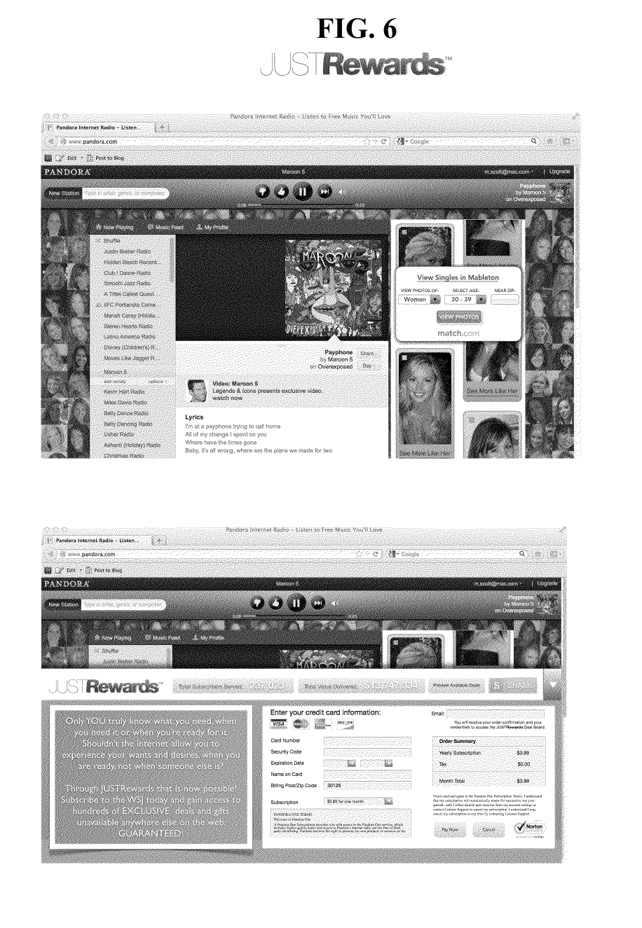

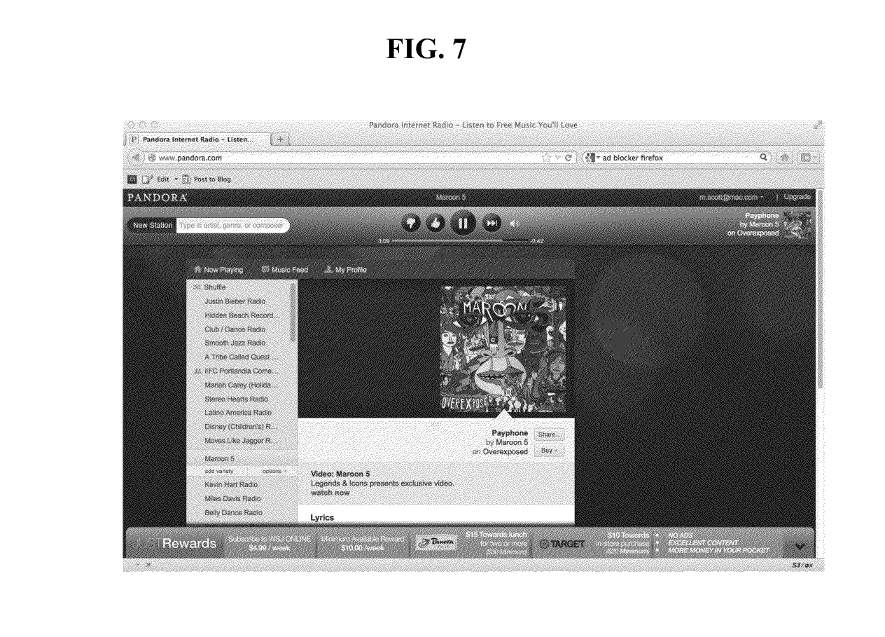

FIG. 6-7 illustrates an exemplary publisher website, in accordance with an embodiment of the invention. In accordance with an embodiment of the invention, the rewards database 240 can be branded as a separate web portal to access the content rewards system, in accordance with some embodiments of the present invention. In this example, the web portal can be branded as JUSTRewards, and used to provide special deals and discounts on goods and services to qualified subscribers. The JUSTRewards web portal can provide an index of deals and discounts exclusively to qualified subscribers.

In accordance with an embodiment of the present invention, the publisher can include a music streaming company, such as Pandora. Referring to FIG. 6, the publisher website includes a link comprising an interface that allows a user or subscriber to directly access the content subscription rewards system 100 to instantly subscribe and register for access to publisher content. The qualifying subscriber can easily complete registration and process payment information for third party credit card and banking providers. Upon successful registration, the qualified subscriber can begin to receive exclusive rewards offered behind the pay wall.

The content subscription rewards system 100 provides a method for publishers to provide their users with exclusive deals and discounts for third party products and services for the purpose of converting said users to subscribers of publisher's service. The content subscription rewards system 100 can also allow a publisher to effectively manage its qualified subscribers and offer targeted rewards. For example, publishers can use the content subscription rewards system 100 to provide offers for exclusive rewards to qualified subscribers and offer different or less exclusive rewards to non-subscribers via its online experience. The special rewards offered via the content subscription rewards system 100 creates an incentive for users to subscribe in order to receive the value of the reward. The increased value of the rewards that content subscription rewards system 100 provides to qualifying subscribers increases the value of the publisher's content and/or service, and may increase the total number of subscribers to publication or service in which these increased revenues may be shared with the publisher. Therefore, the publisher is incentivized to employ the content subscription rewards system 100, and the publisher is positioned to convert more free users into subscribers and subsequently drive higher subscription revenues.

In accordance with an embodiment of the present invention, the rewards database 240 can be used to provide a combination of rewards to qualified subscribers of publisher. The rewards can include multiple categories of goods and services representative of various brands and retailers. For example, the categories can include reward offers for food, clothing, health care, and travel. Also, qualified subscribers can search the rewards database 240 to find such deals. Brands and retailers can use the rewards database 240 to offer one or more rewards for any defined time period. Brands and retailers also may decide to discontinue any reward based on preferences, or use qualified subscriber data. Priority rewards can be offered from within the rewards database 240 based on preferences, or use of qualified subscriber data.

In accordance with an embodiment of the invention, the rewards database 240 can be used by qualified subscribers to compare local rewards of brands and retailers in a qualified subscriber's region to national rewards offered by the brand's competitors. For example, a qualified subscriber can compare a local reward for a coffee retailer, such as Starbucks, with any rewards to a local coffee shop or national competitor, such as Dunkin Donuts, located near the qualified subscriber's geographic location of choice. Likewise, a brand or retailer can use the rewards database 240 to offer matching rewards to a qualified subscriber. For example, Dunkin Donuts can offer to match a reward for free coffee with any brand or retailer in the subscriber's geographic location. Qualified subscribers can also browse and search the JUSTRewards rewards database for products and services that are related to the qualified subscriber's personal interest. Qualified subscribers can elect to receive reward notifications via a subscriber account, personal e-mail, subscriber computer 210 or any other suitable device in communication with the Internet, such as the Internet connected media device 230.

Brands and retailers can use the content subscription rewards system 100 to create rewards at predetermined events or time periods to offer rewards to qualified subscribers to assist in selling excess inventory. For example, Dunkin Donuts can use the content subscription rewards system 100 to notify qualified subscribers of a coffee and donut special at locations near the qualified subscriber, or an electronics retailer, such as Best Buy, can use the content subscription rewards system 100 to notify qualified subscribers of sales of certain items such as computers during the Christmas holiday season. The content subscription rewards system 100 provides brands and retailers with instant access to notify qualified subscribers of deals and discounts that will likely result in sales. Additionally, if the qualified subscriber is interested in the reward offered, the qualified subscriber can elect to receive an instant reward in the form of a coupon via the qualified subscriber's Internet connected media device 230. In another embodiment of the present invention, the rewards listed in the rewards database 240 can be separated into various categories, to provide qualified subscribers with the ability to browse the rewards database 240. The categories can include travel, electronics and entertainment, etc. Qualified subscribers are encouraged to create a subscriber profile and opt to receive special deals and discounts become available that match their subscriber profile. For example, a qualified subscriber that has an interest in movies can elect to receive instant notifications of rewards related to movies in his geographic region. Additionally, a qualified subscriber can elect to receive an instant notification to the qualified subscriber's Internet connected media device 230 for any rewards that are at least 50% off a brand's product or service.

In another embodiment of the present invention, the content subscription rewards system 100 can include a credit card or mobile payment application, wherein the credit card or mobile payment application can be used to debit rewards and accumulate the rewards points of a qualified subscriber. The credit card or mobile payment application can be used to automatically redeem rewards or provide the qualified subscriber the ability to use rewards without having to print a coupon. In addition, the credit card or mobile payment application can be used to accumulate subscriber points for each reward received or each reward redeemed by the qualified subscriber via a purchase of a publisher product or service. A point value can be associated with the corresponding amount of currency spent by a subscriber. The credit card or mobile payment application can be used to offer automatic rewards to qualified subscribers that frequently purchase publisher's products or services, and/or redeem rewards of brand or retailer. In another embodiment of the present invention, the credit card can be branded as a JUSTRewards credit card. Additionally, a credit card can include any type of debit card, stored value card, secured card, or the like, wherein payments or credits can be engaged in any manner. Furthermore, the mobile payment application can include the same payment, value, point and restriction options as said credit card.

In accordance with an embodiment of the present invention, the content subscription rewards system 100 can allow the brand or retailer to offer a reward in the reward database 240 for a predetermined period upon payment of a qualifying subscriber fee. For example, qualifying subscribers may elect to pay for the specified subscription for a limited period with a credit or debit card upon registration wherein upon expiration of the period, the subscription will expire. In accordance with another embodiment of the present invention, the content subscription rewards system 100 can allow the brand to offer a reward in the reward database 240 for a predetermined period, without payment of a subscriber fee. For example, a publisher may offer a free subscription for 30 days for a limited reward. In accordance with another embodiment of the present invention, the content subscription rewards system 100 can be used to onboard publishers with or without the payment of a publisher registration fee.

In accordance with an embodiment of the present invention, the content subscription rewards system 100 can automatically send qualified subscribers a notification regarding the terms and conditions of the subscription, and to send any information regarding any exclusive rewards offered by publishers. In an exemplary embodiment of the invention, the content subscription reward system 100 can provide a pay wall online subscription strategy for publishers that do not currently use a subscription pay wall. Additionally, the content subscription reward system will allow publishers that currently have a subscription pay wall to increase subscription conversion ratios and potentially increase publisher subscription rates. The pay wall allows the publisher to provide full content access, advertisement free, to qualified subscribers in a strategic manner, and also allows the brands and retailers to reach subscribers in local and national locations. Thus, the content subscription rewards system 100 can be used to create additional subscriber revenue, provide rewards to qualified subscribers, and prevent non-subscribers from consuming certain content. Any publisher seeking to distribute its goods and services can utilize the content subscription rewards system 100. For instance, a news or entertainment media company, an online streaming media (i.e. audio, radio, and music) company, a cloud-based storage company, a video conferencing and data sharing company, a search media company, a consumer research and resource company, and a social media company can all be considered a publisher in the content subscription rewards system 100.

In an exemplary embodiment of the invention, certain content may comprise an advertisement of a particular product. In one aspect of the invention, content may comprise a link to a website, online reference, online database, and/or other information related to the particular product. In another aspect of the invention, upon searching for an item related to the particular product by the qualified subscriber, the online experience may comprise a list of links to websites and/or online references related to the particular product. The interactive content may comprise a link to a particular website and/or online references with information on the particular product shown in the advertisement, and the link to the particular website and/or online reference may appear to be a first link on the list.

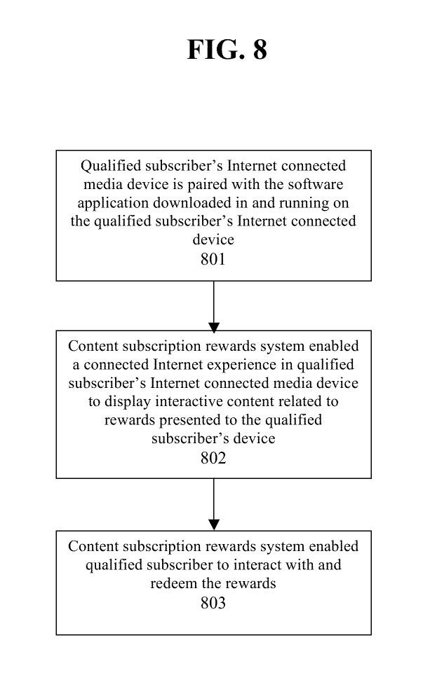

FIG. 8 is a flow chart illustrating exemplary steps for linking rewards on an Internet connected media device, in accordance with an embodiment of the invention. Referring to FIG. 8, in step 801, the rewards software application is enabled on the device and may be paired with or associated with a paired device utilizing the companion software application 250 downloaded in and running on the qualified subscriber's computer 210. In step 802, the qualified subscriber's connected device 230 may be operable to enable, utilizing a content subscription rewards system such as the content subscription rewards system 100 shown in FIG. 1, an online experience in the qualified subscriber's Internet connected media device 230 to display, within a section of online experience, interactive rewards related to certain content being presented by the qualified subscriber's computer 210. In step 803, the content subscription rewards system 100 on qualified subscriber's Internet connected device 230 may be operable to enable, utilizing content subscription rewards system 100, a user such as the qualified subscriber to interact with the rewards.

In an exemplary embodiment of the invention, the rewards may comprise an advertisement of a particular product. In one aspect of the invention, the rewards may comprise a link to a website, online reference, and/or other information related to the particular product. In another aspect of the invention, upon searching for an item related to the particular product by the qualified subscriber, the online experience may comprise a list of links to websites and/or online references related to the particular product. The interactive reward may comprise a link to a particular website and/or online reference with information on the particular product shown in the advertisement, and the link to the particular website and/or online reference may appear to be a first link on the list.

Other embodiments of the invention may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the steps as described herein for linking content on an Internet connected media device and/or other Internet connection services.

Accordingly, the present invention may be realized in hardware, software, or a combination of hardware and software. The present invention may be realized in a centralized fashion in at least one computer system or in a distributed fashion where different elements are spread across several interconnected computer systems. Any kind of computer system or other apparatus adapted for carrying out the methods described herein is suited. A typical combination of hardware and software may be a general-purpose Internet connected computer system with a computer program that, when being loaded and executed, controls the computer system such that it carries out the methods described herein.

The present invention may also be embedded in a computer program product, which comprises all the features enabling the implementation of the methods described herein, and which when loaded in an Internet connected computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method of providing and consuming publisher content in an Internet connected media device, comprising:
registering a user to a subscription comprising publisher content, wherein said completed registration will convert the user to a qualified subscriber to provide said qualified subscriber access to consume publisher content via an online experience;
enabling the qualified subscriber to access said publisher content without any third party advertisement;
providing at least one reward to said qualified subscriber upon payment of a subscription fee to the publisher content; and
enabling the qualified subscriber to select at least one reward within a rewards database.

2. The method according to claim 1, further comprising the step of enabling at least one publisher to provide the qualified subscriber to automatically receive a plurality of rewards.

3. The method according to claim 1, further comprising the step of enabling a plurality of qualified subscribers to access publisher content.

4. The method according to claim 1, wherein said section of said online experience is changed dynamically.

5. The method according to claim 1, wherein said certain reward comprises an advertisement of a particular reward.

6. The method according to claim 5, wherein said reward comprises a link to an online database and/or other information related to said particular reward.

7. The method according to claim 5, wherein, upon searching for an item related to said particular reward by said qualified subscriber, said online experience comprises a list of links to online references related to said particular reward.

8. The method according to claim 1, wherein the reward is offered to a qualified subscriber for a predetermined period.

9. The method according to claim 1, wherein a qualified subscriber can receive a plurality of rewards related to publisher content.

10. The method according to claim 1, wherein publisher content comprises any products or services of said publisher.

11. An apparatus for converting free users into subscribers comprising:
an online experience comprising at least one link to a rewards database consisting of at least one reward;
an Internet connected media device;
a qualified subscriber computer;
a software application in communication with the rewards database and the Internet connected media device;
a software application which allows a qualified subscriber to browse the rewards database; and
a software application which, using the link to query the rewards database, identifies at least one reward in the reward database;

12. The apparatus of claim 11, where the reward related to a search by a qualified subscriber is sent to the Internet connected media device.

13. The apparatus of claim 11, wherein the Internet connected media device includes at least one Internet connected media device selected from the group comprising a mobile phone, smartphone, tablet or consumer appliance.

14. The apparatus of claim 11, wherein the Internet connected media device includes at least one Internet connected media device selected from the group comprising an MP3 player, game console, computer, cable set top box or television.

15. The apparatus of claim 11, wherein the Internet connected media device comprises a. pay wall that prevents a user from accessing the publisher content without a paid subscription.

16. A system, comprising:
a content subscription rewards-enabled computer coupled to a content subscription rewards system, said content subscription rewards-enabled computer being paired with or associated with an Internet connected media device utilizing a software application running on said Internet connected media device to provide a user an online experience, and said content subscription rewards-enabled computer is operable to:
enable, utilizing said content rewards system, said online experience to display, within a section of an online experience, an interactive reward related to the certain reward being presented by said content subscription rewards-enabled computer; and
enable, utilizing said content subscription rewards system, a qualified subscriber to interact with said interactive reward.

17. The system according to claim 16, wherein said section of said online experience is changed dynamically.

18. The system according to claim 16 wherein said software application comprises ad blocking software to block advertisements from being displayed in said publisher content.

19. The system according to claim 16, wherein said interactive reward comprises a link to an online reference and/or other information related to said interactive reward.

20. The system according to claim 16, wherein, upon searching for an item related to said interactive reward by said qualified subscriber, said online experience comprises a list of links to online references related to said interactive reward.
